(19) United States
(12) Patent Application Publication
(10) Pub. No.: US 2025/0214244 A1
(43) Pub. Date: Jul. 3, 2025

(54) ROBOT TELEOPERATION SYSTEM AND METHOD

(71) Applicants: SHANGHAI FLEXIV ROBOTICS TECHNOLOGY CO., LTD., Shanghai (CN); FLEXIV LTD., Grand Cayman (KY)

(72) Inventors: Peizhang ZHU, Shanghai (CN); Wenbo TANG, Shanghai (CN); Zhan Fan QUEK, Singapore (SG); Xiyang YEH, Santa Clara, CA (US)

(21) Appl. No.: 18/263,061

(22) PCT Filed: Sep. 7, 2022
(86) PCT No.: PCT/CN2022/117629

§ 371 Date: Jul. 26, 2023

(51) Int. Cl. B25J 9/16

(52) U.S. Cl. CPC B25J 9/1689

(57) ABSTRACT

The present disclosure provides a robot teleoperation system comprising a master robot, a slave robot, and a control system configured to cause the slave robot to follow the movement of the master robot. The control system is further configured to determine a coefficient K and determine a control force F output by the slave robot at the selected point based on the coefficient K and a displacement error between a reference point on the master robot and a selected point on the slave robot corresponding to the reference point.

### TECHNICAL FIELD

The present disclosure relates to the field of robotics, and particularly to a robot teleoperation system and method.

### BACKGROUND

With the development of technology, robots are widely used in various fields and have different types and structures. For example, an articulated robot has multiple of rotatable joints so as to achieve movement within a certain spatial range.

The control of the robot can be achieved by teleoperation. In an implementation, a master robot is required and manually operated, and a slave robot is configured to follow the motion of the master robot. In one scenario, the robot is taught to perform motions by robot teleoperation, and is programmed based on the data generated during the teaching. The teaching produces operation instructions that can be executed automatically by the robot. In another scenario where the environment is quite complex and the robot is difficult to be operated automatically or to be programed, the robot can be controlled remotely to preform operations in the complex environment.

Existing remote control of robots may lead to unintended movements of the slave robot or overdriving by the operator due to, for example, communication issues or environmental reasons, and consequently produce excessive contact forces between the slave robot and a workpiece or an obstacle, which leads to damage to the workpiece or robot.

### SUMMARY

One aspect of the present disclosure provides A robot teleoperation system, which includes a master robot, a slave robot and a control system configured to cause the slave robot to follow a motion of the master robot. The control system is further configured to determine a coefficient K, and determine a control force F output by the slave robot at a selected point on the slave robot based on the coefficient K and a displacement error between a reference point on the master robot and the selected point on the slave robot. The selected point corresponds to the reference point.

Another aspect of the present disclosure provides a robot teleoperation method, which includes acquiring a displacement of a reference point on a master robot and a displacement of a selected point on a slave robot corresponding to the reference point, and determine a coefficient K and determining a control force F output by the slave robot at the selected point based on the coefficient K and a displacement error between the displacement of the reference point and the displacement of the selected point.

Yet another aspect of the present disclosure provides a computer device, which includes a memory and a processor, the memory having a computer program stored therein. The computer program, when executed by the processor, causes the processor to perform steps of the above robot teleoperation method.

Yet another aspect of the present disclosure provides a readable storage medium having a computer program stored therein. The computer program, when executed by a processor, causes the processor to perform steps of the above robot teleoperation method.

Details of one or more embodiments of the present disclosure are set forth in the accompanying drawings and description below. Other features, objects, and advantages of the disclosure will become apparent from the description, the drawings, and the claims.

### BRIEF DESCRIPTION OF THE DRAWINGS

The foregoing and other objects, features and advantages of the invention will become apparent from the following description of particular embodiments of the invention, as illustrated in the accompanying drawings. The drawings are not necessarily to scale, emphasis instead being placed upon illustrating the principles of the invention.

FIG. 1 a schematic diagram of a robot teleoperation system according to an embodiment of the present disclosure;

FIG. 2 shows an architecture of a robot teleoperation system according to an embodiment of the present disclosure;

FIG. 3 is a schematic diagram of the robot teleoperation system of the embodiment shown in FIG. 1, in which a displacement of a selected point deviates from that of a reference point;

FIG. 4 is a flowchart of a robot teleoperation method according to an embodiment of the present disclosure; and

FIG. 5 shows an architecture of a computer device according to an embodiment of the present disclosure.

### DESCRIPTION OF THE EMBODIMENTS

In order to make the above objects, features and advantages of the present application more apparent and better understood, embodiments of the disclosure will be fully described hereinafter with reference to the drawings. Numerous specific details are set forth in the following description in order to provide a thorough understanding of the present application. However, the present application can be implemented in many other ways different from those described herein, and a person skilled in the art can make similar modifications without departing from the application, and therefore, the present application is not limited by the specific embodiments disclosed below.

The present application provides a robot teleoperation system which includes a master robot, a slave robot, and a control system. The control system is configured to cause the slave robot to follow a motion of the master robot, and configured to determine a coefficient K and determine a control force F output by the slave robot at a selected point on the slave robot based on the coefficient K and a displacement error between a displacement of a reference point on the master robot and a displacement of the selected point on the slave robot. The selected point corresponds to the reference point.

According to the robot teleoperation system of the present application, a reference point and a selected point are set at corresponding positions on the master robot and the slave robot, respectively, and the control force F output by the slave robot at the selected point is determined based on the coefficient K and the displacement error between the displacements of the selected point and the reference point. In some scenarios, it is able to prevent damages to components of the slave robot or external objects such as workpieces or obstacles due to excessive control force.

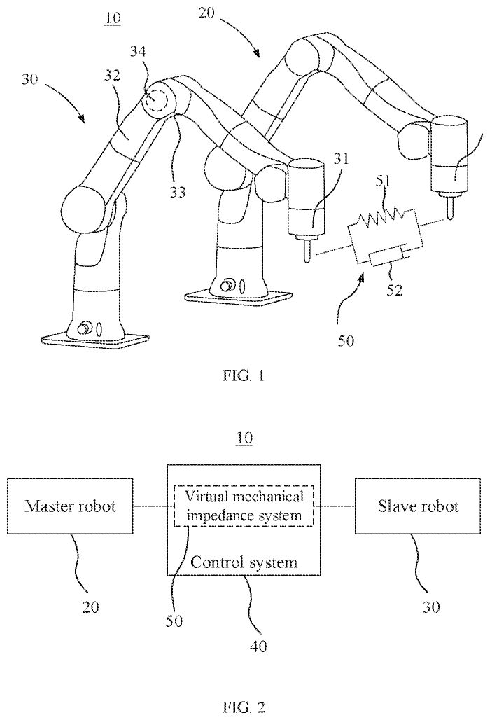

FIG. 1 is a schematic diagram of the robot teleoperation system of an embodiment of the present disclosure, and FIG. 2 shows an architecture of the robot teleoperation system of an embodiment of the present disclosure. Referring to FIG. 1 and FIG. 2, the robot teleoperation system 10 includes a master robot 20, a slave robot 30, and a control system 40 communicatively connected to the master robot 20 and the slave robot 30. The control system 40 may be same as a controller of the master robot 20 or a controller of the slave robot 30, or may be an independent control system other than the robots' own control systems. In structure, the control system 40 may be provided inside the master robot 20 or the slave robot 30, or may be discrete from the master robot 20 and the slave robot 30 to remotely control the robots.

The master robot 20 and the slave robot 30 may be of the same structure. Taking the slave robot 30 as an example, the slave robot 30 includes a slave end effector 31 and a plurality of arms 32 connected in series, with the end effector 31 located at the end of the connected arms 32. A plurality of joints 33 are formed between adjacent arms 32 and between the arm 32 and slave end effector 31, and each joint 33 is equipped with an actuator 34, such as an electric motor, for driving the arm 32 or the slave end effector 31. The plurality of joints 33 ensure multiple degrees of freedom of movements of the slave end effector 31.

In an embodiment, the control system 40 is configured to determine the coefficient K such that a portion Fₑₓₜ of the control force F at the selected point is less than or equal to a predetermined threshold Fₗᵢₘ. The portion Fₑₓₜ includes one portion of the control force F which serves to balance a contact force between the slave robot 30 and an external object and another portion of the control force F which serves to drive the slave robot 30 to follow a motion of the master robot 20.

In an embodiment, the control system 40 is further configured to maintain the coefficient K at a predetermined value K₀ when the portion Fₑₓₜ is less than the predetermined threshold Fₗᵢₘ, and adjust the coefficient K when the portion Fₑₓₜ reaches the predetermined threshold Fₗᵢₘ such that the portion Fₑₓₜ is less than or equal to the predetermined threshold Fₗᵢₘ.

In an embodiment, the control system 40 is further configured to, when the portion Fₑₓₜ reaches the predetermined threshold Fₗᵢₘ, adjust the coefficient K based on the displacement error such that the portion Fₑₓₜ is less than or equal to the predetermined threshold Fₗᵢₘ.

In an embodiment, the control system 40 provides a virtual mechanical-impedance system 50 between the master robot 20 and the slave robot 30 for controlling the slave robot 30 with the master robot 20, which enables teleoperation of the slave robot 30. It is noted that the virtual mechanical-impedance system 50 is not a physical hardware, but is a computer-based control model that is just logically similar to a physical mechanical-impedance system, and is used in this disclosure to calculate and determine the forces and torques applied to the slave robot 30. When the master robot 20 moves by manual control of an operator, the control system 40 is configured to cause the slave robot 30 to follow the motion of the master robot 20. Specifically, the control system 40 generates instructions for controlling the motion of the slave robot 30 based on relevant parameters generated according to the motion of the master robot 20 and also with the help of the virtual mechanical-impedance system 50, and controls the motion of the slave robot 30 based on the instructions, i.e., maintaining same poses and positions as the master robot 20.

It will be understood that the virtual mechanical-impedance system 50 may be provided in the control system 40 in advance, or the virtual mechanical-impedance system 50 may be created and adjusted in real time during teleoperation of the slave robot 30 based on relevant parameters.

In this embodiment, the reference point and the selected point are corresponding points on a master end effector 21 of the master robot 20 and the slave end effector 31 of the slave robot 30, respectively. It will be understood that in other embodiments, the reference point and the selected point may be set on other components of the robots as desired. The application of the virtual mechanical-impedance system 50 of the present disclosure will be described in detail below with reference to specific embodiments.

A dynamics equation of the slave end effector 31 in Cartesian space is:

$$Λ ( x ) \ddot{x} + μ ( x , \dot{x} ) + p ( x ) + {F}_{e x t} = F \qquad ( 1 )$$

where x is the displacement of the slave end effector 31 (e.g. using the tool center point TCP as the reference), \ddot{x} is the second order derivative of x, A(x) is the inertia matrix (e.g. under the Cartesian space) of the slave robot 30 at the selected point, i.e., the inertia matrix of the slave robot 30 with the selected point as the origin of a body frame, \dot{x} is the first order derivative of x, μ(x, \dot{x}) is the centrifugal and Coriolis force matrix of the slave robot 30 at the selected point, p(x) is gravity matrix of the slave robot 30 at the selected point, and F is the control force for controlling the motion of the slave end effector 31.

It should be understood that, in the case that the slave robot is not following the motion of the master robot, the portion Fₑₓₜ only includes an equivalent external force on the slave end effector 31 when the slave robot 30 is in contact with an external object. When the slave end effector 31 moves in space, whether it touches a workpiece or an obstacle, an external force is generated on the slave end effector 31, i.e. the contact force between the slave end effector 31 and the workpiece or obstacle. If the external force is too large, damage to the slave end effector 31, the workpiece or the obstacle may occur. Therefore, the control force F on the slave end effector 31 needs to be well controlled such that the external force on the slave end effector 31 can be maintained within a safe range.

It will be understood that the description “control force or external force at the selected point” or “control force or external force on the selected point” in this disclosure represents an equivalent force of the control force output by the slave robot or the external force at the selected point.

In some embodiments, to implement the virtual mechanical-impedance control system 50, the control system 40 is further configured to dynamically determine a coefficient K and determine a control force F based on the coefficient K and the displacement error between the master end effector 21 and the slave end effector 31. In an embodiment, the control system 40 actively configures the control force based on the following condition:

$$F = \hat{Λ} ( x ) \ddot{x} + \hat{μ} ( x , \dot{x} ) + \hat{p} ( x ) + K ( {x}_{d} - x ) + D ( {\dot{x}}_{d} - \dot{x} ) \qquad ( 2 )$$

where \hat{Λ}(x) is an inertia matrix of the slave robot 30 at the selected point based on a dynamics model of the slave robot, \hat{μ}(x, \dot{x}) is the centrifugal and Coriolis force matrix of the slave robot 30 at the selected point based on the slave robot dynamics model, \hat{p}(x) is a gravity matrix of the slave robot 30 at the selected point based on the dynamics model, x_{d} is the displacement of the reference point, x is the displacement of the selected point, x′_{d} is the first order derivative of x_{d}, \dot{x} is the first order derivative of x, \ddot{x} is the second order derivative of x, and D is a virtual damping coefficient.

It will be understood that in some embodiments, the coefficient K and the virtual damping coefficient D may be a matrix of coefficients under Cartesian space, respectively.

Since the selected point is theoretically expected to follow the motion of the reference point exactly, the displacement x_{d} of the reference point is also an expected displacement of the selected point. The displacement x of the selected point and the displacement x_{d} of the reference point can be measured by various displacement sensors, or obtained from other control parameters. For example, the rotation amount of the joints of the robots can be calculated based on the data of the motor encoders, and the displacements of the robot end effectors can be thus obtained based on the kinematics of the robots. The control system 40 is configured to obtain the displacement x of the selected point and the displacement x_{d} of the reference point from, for example, the displacement sensors mentioned above. In an embodiment, the displacement x of the selected point and the displacement x_{d} of the reference point are vector parameters each involving both moving distance and orientation, which represent the position and pose of the master end effector 21 or the slave end effector 31, respectively.

The component K(x_{d}−x) in equation (2) corresponds to a virtual spring 51 in the virtual mechanical-impedance system 50, where K can be thus called virtual spring coefficient. As the amount of deformation of this virtual spring increases, the elastic force generated by the virtual spring increases accordingly. The component D(x′_{d}−\dot{x}) corresponds to a virtual damper 52 in the virtual mechanical-impedance system 50. Both the coefficient K and the coefficient D can be assigned default values in advance, and the default values can be obtained by debugging depending on needs.

According to equations (1) and (2), equation (3) can be obtained:

$${F}_{ext} = {Kx}_{e} + D {\dot{x}}_{e} + \hat{Λ} {\ddot{x}}_{e} \qquad ( 3 )$$

where xₑ is the error between x_{d} and x, \dot{x}ₑ is the error between x′_{d} and \dot{x}, and \ddot{x}ₑ is the error between the second order derivative of x_{d} and the second order derivative of x.

By introducing the virtual mechanical-impedance system 50, the portion Fₑₓₜ calculated according to equation (3) contains an equivalent force generated by two types of the force at the selected point of the slave robot 30, i.e. one portion of the control force F which serves to balance a contact force between the slave robot 30 and an external object and another portion of the control force F which serves to drive the slave robot 30 to follow a motion of the master robot 20.

In an embodiment, the control system 40 is further configured to adjust the coefficient K based on a change of the displacement error xₑ, such that the portion Fₑₓₜ is maintained less than or equal to a predetermined threshold Fₗᵢₘ.

Referring to FIG. 3, the value of A\ddot{x}ₑ is equal to zero, and the value of D\dot{X}ₑ is equal to a constant C when the salve end effector 31 is contacting with an external object in a stationary state and the master end effector 21 is moving at a constant speed. In this case, equation (4) can be obtained:

$${F}_{ext} = {Kx}_{e} + C \qquad ( 4 )$$

The value of D\dot{x}ₑ becomes zero when the master end effector 21 and the slave end effector 31 further enter a steady state, i.e., both entering a stationary state or moving in synchronous way at a constant speed. In this case, equation (5) can be obtained:

$${F}_{ext} = {Kx}_{e} \qquad ( 5 )$$

It can be seen that, in these cases, the portion Fₑₓₜ can be maintained less than or equal to the predetermined threshold Fₗᵢₘ by adjusting the coefficient K, thereby ensuring that no damage is caused to the slave end effector 31 and external objects such as workpieces or obstacles.

In an embodiment, the coefficient K in the virtual mechanical-impedance system 50 is maintained at the default value K₀ before the portion Fₑₓₜ reaches the predetermined threshold Fₗᵢₘ. When the slave end effector 31 and the external object begin to contact with each other, the slave end effector 31 stops moving as it is blocked, and thus the displacement error xₑ increases gradually as the displacement x_{d} of the reference point increases gradually. According to equation (3), the control force F also increase continuously. During this period, the portion Fₑₓₜ can be continuously calculated or monitored by, for example, detection by a contact force and/or torque sensor located at the slave end effector 31 or estimation through measured joint torques, or by calculation according to the above equation (3).

When the portion Fₑₓₜ reaches the predetermined threshold Fₗᵢₘ, the coefficient K is adjusted based on the displacement error to maintain the portion Fₑₓₜ less than or equal to the predetermined threshold. For example, a close-loop control method can be adopted during this period, and the coefficient K is adjusted downward continuously as the displacement error xₑ continues to rise, which is equivalent to making the virtual spring gradually “softer”. The closed-loop control of K and the portion Fₑₓₜ can be achieved in common ways and is not described in this disclosure.

It will be understood that the description “less than or equal to a threshold” in this disclosure means that the portion Fₑₓₜ can be maintained substantially less than or equal to the predetermined threshold under normal circumstances, but it does not exclude the case that the portion Fₑₓₜ appears above the predetermined threshold briefly or accidentally. For example, there may be a case where the portion Fₑₓₜ oscillates at the predetermined threshold due to, for example, communication or calculation delays.

There may also be a situation where the slave end effector 31 is in dynamic contact with an external object, that is, the slave end effector 31 is in a varying state during the contact. In the case of dynamic contact, according to equation (3), the values of D\dot{x}ₑ and A\ddot{x}ₑ are not equal to zero any more. However, it is still able to control the portion Fₑₓₜ by adjusting the coefficient K. For example, the control force F may rise sharply in a short period of time, causing a large acceleration of the slave end effector 31 and therefore generating a large dynamic external force on the end effector 31. At this point, the portion Fₑₓₜ can be controlled to be, for example, less than or equal to the predetermined threshold by adjusting the coefficient K.

In an embodiment, the coefficient K is kept unchanged, and in this case, equation (6) can be obtained according to equation (3):

$${F}_{ext} ( {K}_{0} ) = {K}_{0} {x}_{ε} + D {\dot{x}}_{e} + {Λ}^{︵} {\ddot{x}}_{e} \qquad ( 6 )$$

where Fₑₓₜ(K₀) represents a calculated value of the portion Fₑₓₜ with K₀ as the coefficient.

It will be understood that, before the portion Fₑₓₜ reaches the predetermined threshold Fₗᵢₘ, Fₑₓₜ(K₀) represents a true portion of the control force which serves to balance a contact force between the slave robot 30 and an external object and to drive the slave robot 30 to follow a motion of the master robot 20, and when Fₑₓₜ(K₀) is greater than the predetermined threshold Fₗᵢₘ, Fₑₓₜ(K₀) is only a virtual value to be used in the calculation of the required coefficient K in the actual control process.

In an embodiment, the portion Fₑₓₜ is maintained at the predetermined threshold Fₗᵢₘ when the portion Fₑₓₜ reaches the predetermined threshold Fₗᵢₘ. In this case, the confident K satisfies the following equation:

$${F}_{lim} = {Kx}_{ε} + D {\dot{x}}_{e} + {Λ}^{︵} {\ddot{x}}_{e} \qquad ( 7 )$$

Equation (8) can be further obtained by transforming the equation (7):

$$K = \frac{{F}_{lim} - ( D {\dot{x}}_{e} + {Λ}^{︵} {\ddot{x}}_{e} )}{{X}_{e}} \qquad ( 8 )$$

Also, equation (9) can be obtained according to equation (6) and equation (7):

$$K = {K}_{0} \frac{{F}_{lim} - ( D {\dot{x}}_{e} + {Λ}^{︵} {\ddot{x}}_{e} )}{{F}_{ext} ( {K}_{0} ) - ( D {\dot{x}}_{e} + {Λ}^{︵} {\ddot{x}}_{e} )} \qquad ( 9 )$$

It can be seen that, when the slave end effector 31 is in the dynamic state, the coefficient K can be determined by equation (8) or equation (9), so that the portion Fₑₓₜ is maintained at the predetermined threshold Fₗᵢₘ.

When the slave end-effector 31 is in the stationary state, equation (9) can be simplified to equation (10):

$$K = {K}_{0} \frac{{F}_{lim}}{{F}_{ext} ( {K}_{0} )} \qquad ( 10 )$$

It shows that, when the slave end-effector 31 in the stationary state, it is also possible to determine the coefficient K by equation (10) so that the portion Fₑₓₜ is maintained at the predetermined threshold Fₗᵢₘ.

According to the embodiment described above, an initial coefficient K₀ is used to adjust the control force F before the portion Fₑₓₜ reaches the predetermined threshold Fₗᵢₘ, and when the portion Fₑₓₜ reaches the predetermined threshold Fₗᵢₘ, the coefficient K is adjusted based on equations (8) and (9) so that the portion Fₑₓₜ can be stabilized at the predetermined threshold Fₗᵢₘ. It will be understood that in another embodiment, the coefficient K can be determined directly based on equations (8) and (9) throughout the process, which aims to maintain the portion Fₑₓₜ at the predetermined threshold Fₗᵢₘ from the beginning, without depending on the changes of the displacement error.

In an embodiment, the control system 40 is configured to control at least one actuator of the master robot 20 to provide tactile feedback to the operator based on the portion Fₑₓₜ. When a component of the slave robot 30 such as the slave end effector 31 contacts an external object, an external force is generated on the slave end effector 31, which may be detected by a force sensor located at the end of the slave end effector 31, or calculated with joint torques. The control system 40 is configured to feed this external force back to the operator such that the operator can intuitively feel the presence of the external force and its changes when operating, for example, the master end effector 21 of the master robot 20, and accordingly adjust the operation of the master robot 20. For example, if the operator has felt that the external force is too large, he or she may reduce the speed of the master robot 20 or stop the operation of the master robot 20, thereby preventing accidents such as damage from occurring. In addition, when the displacement error between the slave robot 30 and the master robot 20 is large, the operator can also intuitively feel the inertial force that the slave robot 30 has to overcome to follow the motion of the master robot 20, according to the calculation of the portion Fₑₓₜ mentioned previously, and thus adjust the operation accordingly (e.g., slowing down the motion of the master robot 20).

In some embodiments, the control force F applied to the slave end effector 31 includes a combined driving force on the slave end effector 31 generated by at least one actuator of the joint. In another embodiment, the control force F includes a driving force on the slave end effector 31 generated by an actuator that directly drives the slave end effector 30.

In some embodiments, the control system 40 is configured to continuously calculate and adjust the control force F at a predetermined frequency. The higher the predetermined frequency, the more responsive the slave robot 30 is to the motion of the master robot 20, and meanwhile, the control force F is more accurate.

According to an embodiment described above, the control system 40 configures the control force F according to equation (2) such that the control force F includes a virtual spring component and a virtual damper component. It will be understood that in other embodiments, the control force F may include only the virtual spring component, or a combination of the virtual spring component and other components, which can also achieve control of the portion Fₑₓₜ applied to the slave robot 31 by the adjustment of the coefficient K.

The present disclosure also provides a robot teleoperation method, which will be described below, with reference to the teleoperation system according to various embodiments described above.

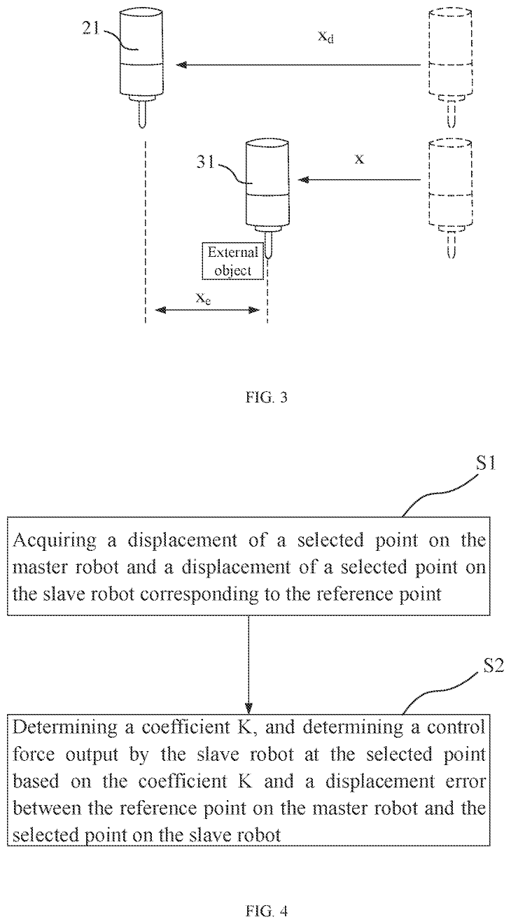

As shown in FIG. 4, the robot teleoperation method of the present disclosure includes:
S1: acquiring a displacement of a selected point on the master robot and a displacement of a selected point on the slave robot corresponding to the reference point; and
S2: determining a coefficient K, and determining a control force F output by the slave robot at the selected point based on the coefficient K and a displacement error between the reference point on the master robot and the selected point on the slave robot.

In an embodiment, the control system 40 is configured to determine the coefficient K such that a portion Fₑₓₜ of the control force F at the selected point is less than or equal to a predetermined threshold Fₗᵢₘ. The portion Fₑₓₜ includes one portion of the control force F which serves to balance a contact force between the slave robot and an external object and another portion of the control force F which serves to drive the slave robot 30 to follow a motion of the master robot.

In an embodiment, the control system 40 is further configured to maintain the coefficient K at a predetermined value K₀ when the portion Fₑₓₜ is less than the predetermined threshold Fₗᵢₘ, and adjust the coefficient K when the portion Fₑₓₜ reaches the predetermined threshold Fₗᵢₘ such that the portion Fₑₓₜ is less than or equal to the predetermined threshold Fₗᵢₘ.

In an embodiment, the control system 40 is further configured to, when the portion Fₑₓₜ reaches the predetermined threshold Fₗᵢₘ, adjust the coefficient K based on the displacement error such that the portion Fₑₓₜ is less than or equal to the predetermined threshold Fₗᵢₘ.

In an embodiment, determining the control force F output by the slave robot 30 at the selected point includes establishing a virtual impedance control relation between the master robot 20 and the slave robot 30, and determining the control force F based on the above-described equation (2) and determining the portion Fₑₓₜ based on the above-described equation (3).

In an embodiment, determining the coefficient K such that the portion Fₑₓₜ of the control force F at the selected point is less than or equal to a predetermined threshold Fₗᵢₘ includes: when the portion Fₑₓₜ is less than the predetermined threshold Fₗᵢₘ, maintaining the coefficient K at a predetermined value K₀; and when the portion Fₑₓₜ reaches the predetermined threshold Fₗᵢₘ, adjusting the coefficient K based on the above-described equations (8) or the above-described equations (9).

In an embodiment, when the slave robot 30 is in a stationary state, the coefficient K is determined based on the above-described equation (10).

In an embodiment, the method further includes controlling an actuator of the master robot 20 to provide haptic feedback to an operator based on the portion Fₑₓₜ.

In an embodiment, the selected point is located on the slave end effector 31 of the slave robot 30 and the reference point is located on the master end effector 21 of the master robot 20.

In an embodiment, the control force F includes a combined driving force on the slave end effector 31 generated by at least one actuator of the joint of the slave robot 30.

In an embodiment, the method further includes continuously calculating and adjusting the control force F at a predetermined frequency.

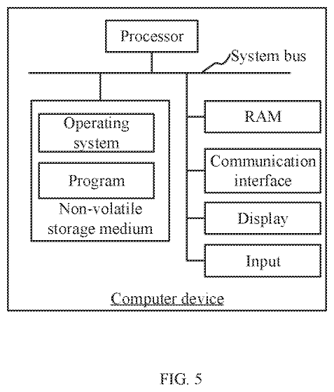

The present disclosure also provides a computer device, which may be the control system 40 described above, and the architecture of which is illustrated in FIG. 5. The computer device includes a processor, a memory, a communication interface, a display, and an input device connected through a system bus. The processor of the computer device is used to provide computing capability and control capability. The memory of the computer device includes a non-volatile storage medium and a Random Access Memory (RAM). The non-volatile storage medium stores an operation system and a computer program. The RAM provides an environment for the operation of the operation system and the computer program in the non-volatile storage medium. The communication interface of the computer device is used for wired or wireless communication with an external terminal. The wireless mode may be realized by WI-FI, an operator network. Near Field Communication (NFC), or other technologies. The computer program, when executed by the processor, causes the processor to perform the steps of the robot teleoperation method as described above, which includes:
S1: acquiring a displacement of a selected point on the master robot and a displacement of a selected point on the slave robot corresponding to the reference point; and
S2: determining a coefficient K, and determining a control force output by the slave robot at the selected point based on the coefficient K and a displacement error between the reference point on the master robot and the selected point on the slave robot.

In other embodiments, other steps that may be implemented when the computer program is executed by the processor and further features related to the steps may be found in the above description of the robot teleoperation method of various embodiments, which are thus omitted herein.

It will be understood by those skilled in the art that the structure illustrated in FIG. 5 is only an architecture diagram, and does not constitute a limitation to the computer device of the present disclosure. The computer device may include more or fewer components than shown in the figure, or have a different arrangement of components.

The present disclosure also provides a readable storage medium having a computer program stored thereon, and the computer program, when executed by a processor, causes the processor to the steps of the robot teleoperation method as described above, which includes:
S1: acquiring a displacement of a selected point on the master robot and a displacement of a selected point on the slave robot corresponding to the reference point; and
S2: determining a coefficient K, and determining a control force output by the slave robot at the selected point based on the coefficient K and a displacement error between the reference point on the master robot and the selected point on the slave robot.

In other embodiments, other steps that may be implemented when the computer program is executed by the processor and further features related to the steps may be found in the above description of the robot teleoperation method of various embodiments, which are thus omitted herein.

It will be understood by those skilled in the art that achieving all or part of the processes in the methods of the above embodiments is possible by means of a computer program to instruct the relevant hardware to do so. The computer program may be stored in a non-volatile readable storage medium, and when the computer program is executed, processes such as those of the embodiments of the methods described above may be performed. Any reference to a memory, storage, database, or other medium used in the embodiments provided in the present disclosure may include at least one of non-volatile and volatile memory. The non-volatile memory may include read-only memory (ROM), magnetic tape, floppy disk, flash memory, or optical memory, among others. The volatile memory may include random access memory (RAM) or external cache memory. As an illustration and not a limitation, the RAM can be in various forms, such as static random access memory (SRAM) or dynamic random access memory (DRAM), etc. The technical features of the above embodiments can be combined in any number of ways. For the sake of brevity, not all possible combinations of the technical features of the above embodiments have been described, however, as long as the combinations of these technical features are not contradictory, they should be considered to be within the scope of the present specification.

The foregoing respective technical features involved in the respective embodiments can be combined arbitrarily, for brevity, not all possible combinations of the respective technical features in the foregoing embodiments are described, however, to the extent they have no collision with each other, the combination of the respective technical features shall be considered to be within the scope of the description.

The above described embodiments express only several embodiments of the present disclosure, and their descriptions are more specific and detailed, but they should not be construed as a limitation of the scope of the present disclosure. It should be noted that for those skilled in the art, a number of variations and improvements can be made without departing from the conception of the present disclosure, and these belong to the scope of present disclosure. Therefore, the scope of the present disclosure shall be subject to the attached claims.

What is claimed is:

1. A robot teleoperation system, comprising:
a master robot;
a slave robot; and
a control system configured to cause the slave robot to follow a motion of the master robot,
wherein the control system is further configured to:
determine a coefficient K; and
determine a control force F output by the slave robot at a selected point on the slave robot based on the coefficient K and a displacement error between a reference point on the master robot and the selected point on the slave robot, wherein the selected point corresponds to the reference point.

2. The robot teleoperation system of claim 1, wherein the control system is configured to determine the coefficient K such that a portion Fₑₓₜ of the control force F at the selected point is less than or equal to a predetermined threshold Fₗᵢₘ;
wherein the portion Fₑₓₜ comprises one portion of the control force F which serves to balance a contact force between the slave robot and an external object and another portion of the control force F which serves to drive the slave robot to follow a motion of the master robot.

3. The robot teleoperation system of claim 2, wherein the control system is further configured to:
maintain the coefficient K at a predetermined value K₀ when the portion Fₑₓₜ is less than the predetermined threshold Fₗᵢₘ; and
adjust the coefficient K when the portion Fₑₓₜ reaches the predetermined threshold Fₗᵢₘ, such that the portion Fₑₓₜ is less than or equal to the predetermined threshold Fₗᵢₘ.

4. The robot teleoperation system of claim 3, wherein the control system is further configured to:
when the portion Fₑₓₜ reaches the predetermined threshold Fₗᵢₘ, adjust the coefficient K based on the displacement error such that the portion Fₑₓₜ is less than or equal to the predetermined threshold Fₗᵢₘ.

5. The robot teleoperation system of claim 2, wherein the control system is further configured to establish a virtual impedance control relation between the master robot and the slave robot, and determine the control force F according to the equation:
$$F = {Λ}^{︵} ( x ) \ddot{x} + \hat{μ} ( x , \dot{x} ) + \hat{p} ( x ) + K * ( {x}_{d} - x ) + D * ( {\dot{x}}_{d} - \dot{x} )$$
where \hat{Λ}(x) is an inertia matrix of the slave robot at the selected point based on a dynamics model of the slave robot, \hat{μ}(x, \dot{x}) is the centrifugal and Coriolis force matrix of the slave robot at the selected point based on the slave robot dynamics model, \hat{p}(x) is a gravity matrix of the slave robot at the selected point based on the dynamics model, x_{d} is the displacement of the reference point, x is the displacement of the selected point, x′_{d} is the first order derivative of x_{d}, \dot{x} is the first order derivative of x, \ddot{x} is the second order derivative of x, and D is a virtual damping coefficient;
wherein the portion Fₑₓₜ is determined based on the equation:
$${F}_{ext} = {Kx}_{ε} + D {\dot{x}}_{e} + {Λ}^{︵} {\ddot{x}}_{e}$$
where xₑ is the error between x_{d} and x, \dot{x}ₑ is the error between x′_{d} and \dot{x}, and \ddot{x}ₑ is the error between the second order derivative of x_{d} and the second order derivative of x.

6. The robot teleoperation system of claim 5, wherein the control system is further configured to:
when the portion Fₑₓₜ is less than the predetermined threshold Fₗᵢₘ, maintain the coefficient K at a predetermined value K₀ and
when the portion Fₑₓₜ reaches the predetermined threshold Fₗᵢₘ, determine the coefficient K based on one of the following equations:
$$K = \frac{{F}_{lim} - ( D {\dot{x}}_{e} + {Λ}^{︵} {\ddot{x}}_{e} )}{{X}_{e}}$$
$$or$$
$$K = {K}_{0} \frac{{F}_{lim} - ( D {\dot{x}}_{e} + {Λ}^{︵} {\ddot{x}}_{e} )}{{F}_{ext} ( {K}_{0} ) - ( D {\dot{x}}_{e} + {Λ}^{︵} {\ddot{x}}_{e} )}$$
wherein Fₑₓₜ(K₀) represents a calculated value of the portion Fₑₓₜ with K being equal to K₀.

7. The robot teleoperation system of claim 6, wherein the control system is further configured to:
when the slave robot is in a stationary state, determine the coefficient K by the following equation:
$$K = {K}_{0} \frac{{F}_{lim}}{{F}_{ext} ( {K}_{0} )}$$

8. The robot teleoperation system of claim 2, wherein the control system is configured to control an actuator of the master robot to provide tactile feedback to an operator operating the master robot based on the portion Fₑₓₜ.

9. The robot teleoperation system of claim 1, wherein the selected point is on a slave end effector of the slave robot and the reference point is on a master end effector of the master robot.

10. The robot teleoperation system of claim 1, wherein the control system is configured to continuously calculate and adjust the control force F at a predetermined frequency.

11. A robot teleoperation method, comprising:
acquiring a displacement of a reference point on a master robot and a displacement of a selected point on a slave robot corresponding to the reference point; and
determining a coefficient K, and determining a control force F output by the slave robot at the selected point based on the coefficient K and a displacement error between the displacement of the reference point and the displacement of the selected point.

12. The method of claim 11, wherein the determining the control force F output by the slave robot at the selected point comprises determining the coefficient K such that a portion Fₑₓₜ of the control force F at the selected point is less than or equal to a predetermined threshold Fₗᵢₘ;
wherein the portion Fₑₓₜ comprises one portion of the control force F which serves to balance a contact force between the slave robot and an external object and another portion of the control force F which serves to drive the slave robot to follow the motion of the master robot.

13. The method of claim 12, wherein the determining the control force F output by the slave robot at the selected point comprises:
maintaining the coefficient K at a predetermined value K₀ when the portion Fₑₓₜ is less than the predetermined threshold Fₗᵢₘ; and
adjusting the coefficient K when the portion Fₑₓₜ reaches the predetermined threshold Fₗᵢₘ, such that the portion Fₑₓₜ is less than or equal to the predetermined threshold Fₗᵢₘ.

14. The method of claim 13, wherein the adjusting the coefficient K when the portion Fₑₓₜ reaches the predetermined threshold Fₗᵢₘ comprises:
adjusting the coefficient K based on the displacement error.

15. The method of claim 12, wherein the determining the control force F output by the slave robot at the selected point comprises establishing a virtual impedance control relation between the master robot and the slave robot and determining the control force F according to the equation:
$$F = {Λ}^{︵} ( x ) \ddot{x} + \hat{μ} ( x , \dot{x} ) + \hat{p} ( x ) + K * ( {x}_{d} - x ) + D * ( {\dot{x}}_{d} - \dot{x} )$$
where \hat{Λ}(x) is an inertia matrix of the slave robot at the selected point based on a dynamics model of the slave robot, \hat{μ}(x, \dot{x}) is the centrifugal and Coriolis force matrix of the slave robot at the selected point based on the slave robot dynamics model, \hat{p}(x) is a gravity matrix of the slave robot at the selected point based on the dynamics model, x_{d} is the displacement of the reference point, x is the displacement of the selected point, x′_{d} is the first order derivative of x_{d}, \dot{x} is the first order derivative of x, \ddot{x} is the second order derivative of x, and D is a virtual damping coefficient;
wherein the portion is determined based on the equation:
$${F}_{ext} = {Kx}_{ε} + D {\dot{x}}_{e} + {Λ}^{︵} {\ddot{x}}_{e}$$
where xₑ is the error between x_{d} and x, \dot{x}ₑ is the error between x′_{d} and \dot{x}, and \ddot{x}ₑ is the error between the second order derivative of x_{d} and the second order derivative of x.

16. The method of claim 15, wherein the determining the coefficient K comprises:
when the portion Fₑₓₜ is less than the predetermined threshold Fₗᵢₘ, maintaining the coefficient K at a predetermined value K₀ and
when the portion Fₑₓₜ reaches the predetermined threshold Fₗᵢₘ, adjusting the coefficient K based on one of the following equations:
$$K = \frac{{F}_{lim} - ( D {\dot{x}}_{e} + {Λ}^{︵} {\ddot{x}}_{e} )}{{X}_{e}}$$
$$or$$
$$K = {K}_{0} \frac{{F}_{lim} - ( D {\dot{x}}_{e} + {Λ}^{︵} {\ddot{x}}_{e} )}{{F}_{ext} ( {K}_{0} ) - ( D {\dot{x}}_{e} + {Λ}^{︵} {\ddot{x}}_{e} )}$$
wherein Fₑₓₜ(K₀) represents a calculated value of the portion Fₑₓₜ with K being equal to K₀.

17. The method of claim 16, wherein the adjusting the coefficient K when the portion Fₑₓₜ reaches the predetermined threshold Fₗᵢₘ comprises:
when the slave robot is in a stationary state, determining the coefficient K by the following equation:
$$K = {K}_{0} \frac{{F}_{lim}}{{F}_{ext} ( {K}_{0} )}$$

18. The method of claim 12, further comprising controlling an actuator of the master robot to provide tactile feedback to an operator operating the master robot based on the portion Fₑₓₜ.

19-22. (canceled)

23. A computer device, comprising a memory and a processor, the memory having a computer program stored therein, wherein the computer program, when executed by the processor, causes the processor to perform operations comprising:
acquire a displacement of a reference point on a master robot and a displacement of a selected point on a slave robot corresponding to the reference point; and
determine a coefficient K, and determining a control force F output by the slave robot at the selected point based on the coefficient K and a displacement error between the displacement of the reference point and the displacement of the selected point.

24. Anon-transitory computer readable storage medium having a computer program stored therein, wherein the computer program, when executed by a processor, causes the processor to perform operations comprising:
acquire a displacement of a reference point on a master robot and a displacement of a selected point on a slave robot corresponding to the reference point; and
determine a coefficient K, and determining a control force F output by the slave robot at the selected point based on the coefficient K and a displacement error between the displacement of the reference point and the displacement of the selected point.
